(19) United States
(12) Patent Application Publication
(10) Pub. No.: US 2022/0261721 A1
(43) Pub. Date: Aug. 18, 2022

(54) COST BENEFIT INDEX

(71) Applicant: Hach Company, Loveland, CO (US)

(72) Inventors: Vishnu Vardhanan Rajasekharan, Fort Collins, CO (US); Russell Young, Fort Collins, CO (US)

(21) Appl. No.: 17/174,888

(22) Filed: Feb. 12, 2021

(51) Int. Cl. G06Q 10/06; G06Q 50/06; C02F 1/00

(52) U.S. Cl. CPC G06Q 10/06313; G06Q 50/06; C02F 2209/006; C02F 2209/001; C02F 1/008

(57) ABSTRACT

An embodiment provides a method, including: receiving, at an electronic device, a data set comprising measured values for a plurality of parameters associated with an upcoming operational process associated with water quality, wherein each of the plurality of parameters is selected from the group consisting of: energy, chemicals, labor, equipment, and a process efficiency value; determining, by at least comparing the measured values against each other, a cost benefit index associated with the upcoming operational process; and providing, based on the determined cost benefit index, a recommendation to maximize a benefit derived from the upcoming operational process based upon a cost to complete the upcoming operational process. Other aspects are described and claimed.

### BACKGROUND

This application relates generally to forecasting the threshold for taking pro-active/real-time approaches to optimize processes.

Maintaining corporate property (e.g., instruments, vehicles, physical distribution systems, other types of property, etc.) in good condition is vital to ensuring that produced products are of high quality and that services are provided to customers safely. If issues with various processes and/or systems are not fixed in a timely manner then the corporation may lose business and the health and safety of employees, customers, and others may be jeopardized. The cost for fixing an issue, and the benefits derived from that cost, must both be considered when devising a plan to fix the issue.

### BRIEF SUMMARY

In summary, one embodiment provides a method, comprising: receiving, at an electronic device, a data set comprising measured values for a plurality of parameters associated with an upcoming operational process associated with water quality, wherein each of the plurality of parameters is selected from the group consisting of: energy, chemicals, labor, equipment, and a process efficiency value; determining, by at least comparing the measured values against each other, a cost benefit index associated with the upcoming operational process; and providing, based on the determined cost benefit index, a recommendation to maximize a benefit derived from the upcoming operational process based upon a cost to complete the upcoming operational process.

Another embodiment provides an electronic device, comprising: a processor; and a memory storing instructions executable by the processor to: receive a data set comprising measured values for a plurality of parameters associated with an upcoming operational process associated with water quality, wherein each of the plurality of parameters is selected from the group consisting of: energy, chemicals, labor equipment, and a process efficiency value; determine, by at least comparing the measured values against each other, a cost benefit index associated with the upcoming operational process; and provide, based on the determined cost benefit index, a recommendation to maximize a benefit derived from the upcoming operational process based upon a cost to complete the upcoming operational process.

A further embodiment provides a computer program product, comprising: a storage device that stores code, the code being executable by a processor and comprising: code that receives a data set comprising measured values of a plurality of parameters associated with an upcoming operational process; code that determines, by at least comparing the measured values against each other, a cost benefit index associated with the upcoming project; and code that provides, based on the determined cost benefit index, a recommendation to maximize a benefit derived from the upcoming operational process based upon a cost to complete the upcoming operational process.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

BRIEF DESCRIPTION OF THE SEVERAL VIEWS OF THE DRAWINGS

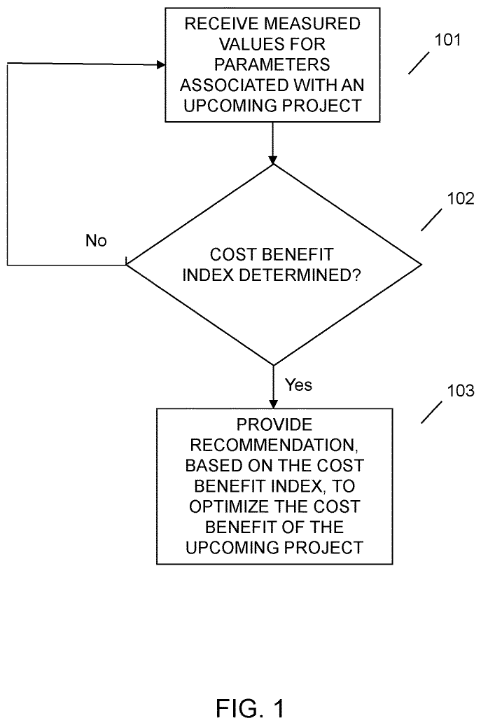

FIG. 1 illustrates a flow diagram that forecasts the cost benefit index of an upcoming operational process.

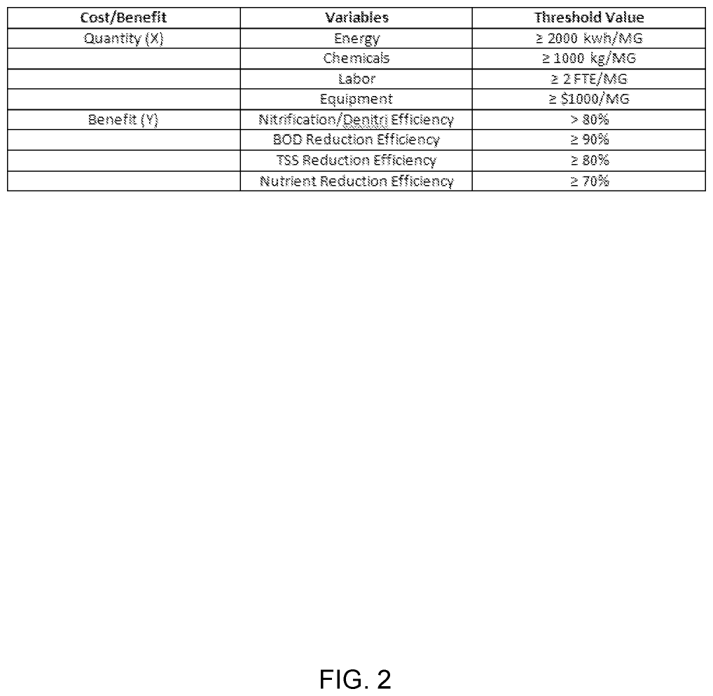

FIG. 2 illustrates a table containing cost and benefit parameters and their requisite threshold levels according to an embodiment.

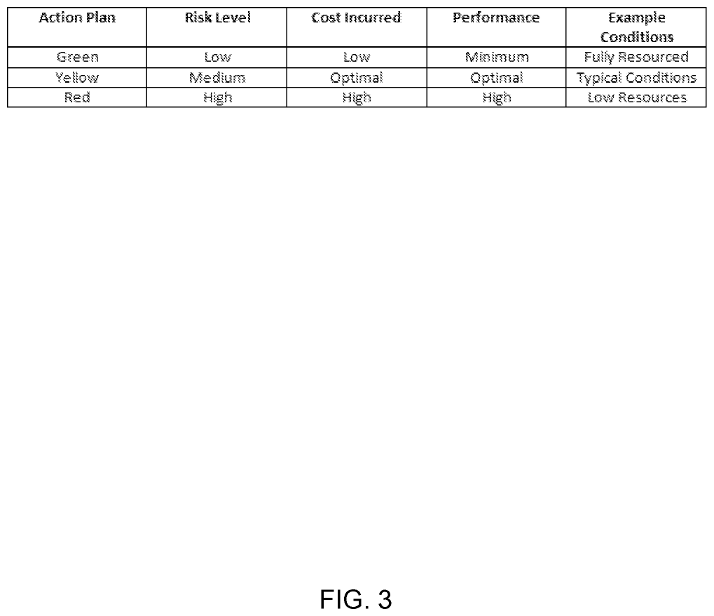

FIG. 3 illustrates a plurality of action plans of varying risk level that may accompany a recommendation.

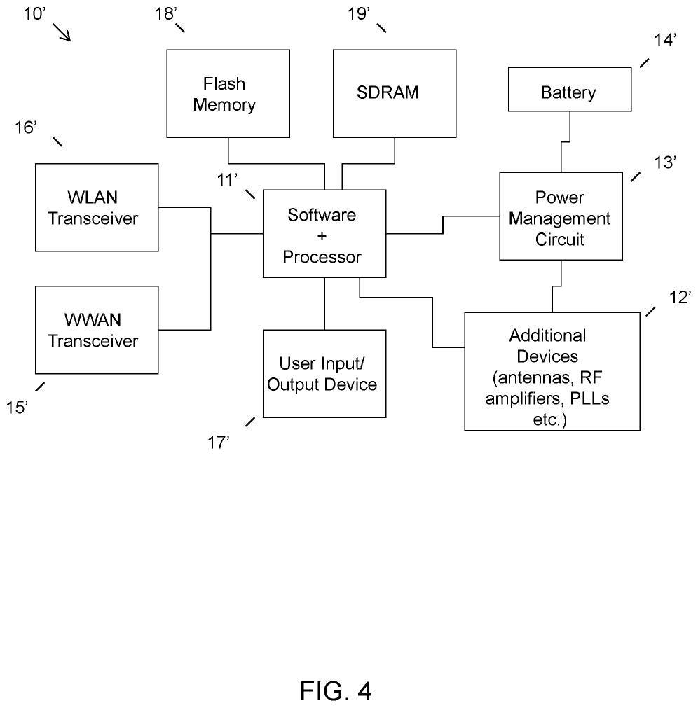

FIG.4 illustrates an example of computer circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

In the context of water treatment and distribution services, a plurality of factors may negatively affect the quality of water as the water travels from a treatment plant to an end user or entity. One factor, for example, may correspond to the corrosive effects of the water transport pipe. More particularly, certain portions of the water transport pipe may begin to shed lead, copper, or other materials over time that may mix with the water contained therein. Additionally or alternatively, small cracks in the pipe could also develop that may allow sediment and/or other materials to mix with the water and consequently degrade its quality. Another factor that may affect the water quality is the formation of disinfection byproducts from the chemicals used to treat the water. For instance, chlorine is frequently used as a disinfectant in water to prevent the growth of, or eliminate the presence of, various types of microorganisms. Although effective, excess chlorine may react with certain organics in the water to form harmful byproducts that negatively affect the water quality. Yet another factor may be the process of nitrification, in which bacteria feed on and proliferate on an ingredient (i.e., ammonia) of a disinfectant (i.e., mono chloramine) used to treat the water. The oxidation of ammonia by the bacteria may subsequently increase the presence of nitrite and nitrate in the water supply, which degrades the water quality. Generally, nitrification in water distribution systems is a pervasive and persistent problem that creates chronic disinfection residual challenges that are time-consuming and costly to address

If left unchecked, all of the above issues may cause serious problems in the water distribution system. Additionally, the health of the individuals who ultimately drink the water may be jeopardized and the water treatment facilities responsible for ensuring the water quality may be subject to regulatory violations. As a result of the foregoing, addressing the above issues in a timely manner is vital. However, identifying a proper action plan that while resolve the issue, while still being cost-effective to the corporation, is difficult. More particularly, the relationship between the cost/benefit factors that can contribute to process optimization is not well understood and may ultimately lead to sub-optimal spending decisions.

Accordingly, an embodiment provides a system and method for generating a cost benefit index value that forecasts the cost of completing an upcoming operational process versus the benefit of having the operational process completed. Based on this index value, a user may be apprised of whether the cost to complete the operational process is worth the benefit that it provides. Additionally, a tailored recommendation may also be provided to a user that provides options for proactive steps that they can take to improve the cost-benefit ratio. In an embodiment, a data set containing measured values for a plurality of different parameters associated with an upcoming operational process may be received at an electronic device. These parameters, or variables, may include cost expenditures (e.g., for energy, chemicals, labor, equipment, etc.) as well as benefit projections (e.g., disinfectant residuals, maintenance efficiency, customer satisfaction, etc.). An embodiment may thereafter analyze these values (e.g., using a dedicated algorithm, etc.) to determine a cost-benefit index. This index may be a single numerical value that projects whether the cost to complete the operational process outweighs the benefit that it provides, or vice versa. Based on this index classification, a tailored recommendation may be provided to a user or corporation. The recommendation may include an indication of the cost-benefit ratio as well as one or more potential action plans (e.g., of various risk levels, etc.) that they can implement to optimize the cost-benefit ratio.

It is important to note that although the majority of the discussion described herein is made in reference to addressing issues related to water treatment and water distribution, such designations are not limiting and the novel concepts described herein may be applicable to optimizing costs to resolve issues in virtually any field or industry.

The illustrated example embodiments will be best understood by reference to the figures. The following description is intended only by way of example, and simply illustrates certain example embodiments.

Referring to FIG. 1, an example system and method for forecasting a cost benefit index associated with an upcoming operational process is illustrated. At 101, a data set containing measured values for a plurality of parameters associated with an upcoming operational process (e.g., a project, a maintenance event, a new construction, etc.) may be received at a device. The parameters may correspond to various types of cost expenditures (e.g., for energy, chemicals, labor, equipment, etc.) as well as benefit projections associated with completion of the upcoming operational process (e.g., disinfectant residuals, maintenance efficiency, customer satisfaction, etc.). The types of cost expenditures and benefit projections may be dependent on the problem itself, the field or industry that the issue is associated with, and the resources available to an entity to resolve the issue. The measurements for these parameters, particularly the cost expenditures, may be deduced from accessing current or historical cost expenditure data (e.g., stored in an accessible database, etc.) for a particular entity. For example, an entity may have data relating to how much gas or electricity is needed to power a certain machine or process, the cost of chemicals needed to treat a predetermined amount of water, the wages of employees involved in the maintenance process, and the like. Additionally or alternatively, in the absence of real measurement data, certain measurements, particularly the benefit projections, may be crowdsourced (e.g., from publicly available data, etc.). For example, a system may have access to knowledge to identifying that solving issue X may result in benefit Y.

In an embodiment, the measurements for these parameters may correspond to a particular past date. The “lag” time between a time period that the measurements are associated with may subsequently influence how far into the future an accurate cost benefit ratio for an upcoming operational process may be forecast.

As briefly described above, in an embodiment, each of the parameters may be categorized into one of two groups: a cost measure and a benefit projection. Parameters associated with the former outline the costs that are expected to be incurred, for each parameter, to complete the upcoming operational process. Values for these parameters may be obtained from accessing current or historical cost expenditure data. Parameters associated with the latter outline the benefits that are projected to be realized from completion of the operational process. As a non-limiting example, and with reference to FIG. 2, a table is provided that illustrates the measurements for the cost measure parameters and benefit projection parameters as they relate to a waste water treatment project. For instance, the projected cost measure parameters needed to complete such a water treatment project may include parameters related to energy expenditures (e.g., gas, electricity, etc.), chemicals involved in the treatment process (e.g., acid/base reagents, coagulants, etc.), labor costs, and equipment (e.g., the costs incurred by the machines and/or instruments involved in the water treatment process, etc.). Also included in the table are the benefits that are projected to result from successful treatment of the water. For instance, the projected benefits may include different types of process efficiency values including the efficiency of existing nitrification processes, biochemical oxygen demand (BOD) reduction efficiency (i.e., a common gauge of the effectiveness of wastewater treatment plants), total suspended solids (TSS) reduction efficiency, and nutrient reduction efficiency. It is important to emphasize that the listing of these parameters are not exhaustive and other parameters, not explicitly described here, may also be involved in determining a cost-benefit index, as further described herein. Further illustrated in the table in FIG. 2 are threshold values for each parameter. These threshold values may identify a critical point that, above which, the parameters associated with the cost measure category negatively affect the cost-benefit ratio and, below which, the parameters associated with the benefit projection lose their expected value.

At 102, an embodiment may determine a cost benefit index (“index”) based upon the measured values (i.e., by comparing the cost to complete the upcoming operational process to the benefit that completion of the operational process provides). In an embodiment, the index may be a single numerical value that is representative of the relationship between the projected cost to complete an upcoming operational process versus the benefits that the completed operational process may provide. In an embodiment, a cost benefit index threshold (“CBI threshold”) may be identified. The CBI threshold may act as a point of comparison to determine the value of the upcoming project. More particularly, if the determined index value is greater than the CBI threshold, then the cost to perform the upcoming project outweighs the benefit(s) that completion of the project provides. Conversely, if the determined index value is lower than the CBI threshold, then the benefit(s) associated with completion of the project are well worth the project's cost. Additionally, if the determined index value is substantially equivalent to the CBI threshold then the cost of the project is roughly equivalent to the benefits that can be expected from the project's completion. In an embodiment, the CBI threshold may originally be set by a manufacturer or programmer but may later be adjusted by a user.

As previously mentioned, the index may be a single, numerical figure that may be representative of the value of an upcoming project based upon identification of the expected costs and corresponding benefits associated with the project's completion. Such a numerical figure may be calculated using the following algorithm:

$${P ( C B I )}_{( t + H )} = \frac{{β}_{0} + {β}_{1} {X}_{1 ( t - L )} + {β}_{2} {X}_{2 ( t - L )} . . . + {β}_{n} {X}_{n ( t - L )} )}{{χ}_{0} + {χ}_{1} Y {1}_{( t - L )} + {χ}_{2} {Y}_{2 ( t - L )} . . . + {χ}_{n} {Y}_{n ( t - L )} )}$$

This algorithm considers the measured values for the parameters involved in the upcoming project and also balances the lag time (L) from when the measurements were taken to identify a horizon time (H) for which the index value (i.e., the CBI) may be applicable.

At 103, using the index value an embodiment may provide a recommendation to an individual or entity designated to perform the upcoming project. In an embodiment, the recommendation may include an indication of the cost benefit projected for the project (i.e., whether the cost of the project is expected to be greater than or worse than the benefit the project provides). A recommendation may be based solely on this indication. For example, if an embodiment determines that that the index number is greater than the CBI threshold, then an embodiment may recommend that the project not be undertaken given the current parameters. Conversely, if an embodiment determines that the index number is less greater than the CBI threshold, than an embodiment may provide confirm that completion of the projected has a cost benefit value to the corporation.

In an embodiment, the recommendation may also include the presentation of a plurality of action plans. Each of these action plans may outline proactive steps that the user/entity may take to optimize the cost benefit index of the upcoming project. Additionally, each suggested action plan may contain a different level of inherent risk. More particularly, given an entity's available capabilities, budget, resources, other environmental factors, index goals, etc., certain plans may be riskier to implement than others, as further described herein. By providing the user with a variety of options, they can choose the action plan that best fits their operational context and goals. Additionally, adherence to the suggestions outlined in the action plans may ultimately lower the cost benefit value for their upcoming project, thereby optimizing the cost to benefit ratio.

In further consideration of the foregoing and with reference to FIG. 3, a sample recommendation including three separate potential action plans may be provided to a user. It is important to note that the number of action plans presented to the user is not restrictive and that more or less action plans may be provided (e.g., based on adjustable user preferences, etc.).

The first action plan may have a “Green” designation that may indicate that the plan is a low risk to implement. The risk determination may be based upon one or more factors. For instance, an embodiment may base the risk determination upon an identification of the resources available to an entity at a particular point in time (e.g., an embodiment may project that an entity will be fully resourced at the time of the project, etc.), the cost to implement the suggestions, the required performance and/or availability of machines and/or other laborers to carry out the suggestions, etc. Additionally, an entity's index goals may also factor into the determination. For example, if the determined index value for the upcoming project is projected to be just over the CBI threshold (e.g., where the CBI threshold is 0.5 and the determined index value for the project is 0.6) and an entity's CBI goal is to lower the index value to be equivalent to or less than the CBI threshold number, then the proactive steps the entity can take to achieve this goal are relatively easy and cost-effective to implement.

The second action plan may have a “Yellow” designation that may indicate that the plan is a medium risk to implement. Such an action plan likely is indicative of most practical operational scenarios. Similar to the “Green” action plan, the risk determination for the second action plan may be based upon a variety of factors. For example, factors contributing to a “Yellow” designation may include: a conventional or expected cost to implement the plan, an expected availability of some resources but not others, an expected availability of some but not all machinery and/or laborers, etc. The entity's index goals may also factor into the risk classification. More particularly, if an entity wanted the index value lowered a moderate amount to reach the CBI threshold value (e.g., from a projected 0.8 to a 0.5) then that leap will require a greater commitment than the “Green” action plan.

The third action plan provided in FIG. 3 contains a “Red” designation that may indicate that the plan is high risk. Such an action plan is costly to implement with respect to an entity's available finances, resources, employees, etc. Additionally, such an action plan may have a very ambitious CBI goal (e.g., from a projected 1+ to a 0.5). More particularly, the obtainment of such a goal may be great but it may be very hard and expensive to do.

The various embodiments described herein thus represent a technical improvement to conventional techniques for forecasting the cost-benefit relationship of an upcoming project. Using the techniques as described herein, an embodiment may receive measured values from a plurality of parameters associated with an upcoming project. Thereafter, using these measured values, a cost benefit index may be determined. Such an index may provide an indication of whether the cost to complete the upcoming project is worth the benefit(s) derived from the project's completion. An embodiment may additionally recommend a plurality of action plans, of varying risk levels, which an entity may follow to optimize the cost benefit index.

While various other circuits, circuitry or components may be utilized in information handling devices, regarding an instrument for measurement of copper and zinc according to any one of the various embodiments described herein, an example is illustrated in FIG. 4. Device circuitry 10′ may include a measurement system on a chip design found, for example, a particular computing platform (e.g., mobile computing, desktop computing, etc.) Software and processor(s) are combined in a single chip 11′. Processors comprise internal arithmetic units, registers, cache memory, busses, I/O ports, etc., as is well known in the art. Internal busses and the like depend on different vendors, but essentially all the peripheral devices (12′) may attach to a single chip 11′. The circuitry 10′ combines the processor, memory control, and I/O controller hub all into a single chip 11′. Also, systems 10′ of this type do not typically use SATA or PCI or LPC. Common interfaces, for example, include SDIO and 12C.

There are power management chip(s) 13′, e.g., a battery management unit, BMU, which manage power as supplied, for example, via a rechargeable battery 14′, which may be recharged by a connection to a power source (not shown). In at least one design, a single chip, such as 11′, is used to supply BIOS like functionality and DRAM memory.

System 10′ typically includes one or more of a WWAN transceiver 15′ and a WLAN transceiver 16′ for connecting to various networks, such as telecommunications networks and wireless Internet devices, e.g., access points. Additionally, devices 12′ are commonly included, e.g., a transmit and receive antenna, oscillators, PLLs, etc. System 10′ includes input/output devices 17′ for data input and display/rendering (e.g., a computing location located away from the single beam system that is easily accessible by a user). System 10′ also typically includes various memory devices, for example flash memory 18′ and SDRAM 19′.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data. The disclosed system may be used in an embodiment to perform measurement of copper and zinc of an aqueous sample.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device, where the instructions are executed by a processor. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and products according to various example embodiments. It will be understood that the actions and functionality may be implemented at least in part by program instructions. These program instructions may be provided to a processor of a device, e.g., a hand held measurement device, or other programmable data processing device to produce a machine, such that the instructions, which execute via a processor of the device, implement the functions/acts specified.

It is noted that the values provided herein are to be construed to include equivalent values as indicated by use of the term “about.” The equivalent values will be evident to those having ordinary skill in the art, but at the least include values obtained by ordinary rounding of the last significant digit.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an electronic device, a data set comprising measured values for a plurality of parameters associated with an upcoming operational process associated with water quality, wherein each of the plurality of parameters is selected from the group consisting of: energy, chemicals, labor, equipment, and a process efficiency value;
determining, by at least comparing the measured values against each other, a cost benefit index associated with the upcoming operational process; and
providing, based on the determined cost benefit index, a recommendation to maximize a benefit derived from the upcoming operational process based upon a cost to complete the upcoming operational process.

2. The method of claim 1, wherein each of the plurality of parameters are associated with one of: a cost measure or a benefit projection.

3. The method of claim 1, wherein the measured values originate from a past time X days before a present time and wherein the cost benefit index corresponds to the upcoming project designated for completion at a future time Y days after the present time, wherein the Y days is at least partially dependent on the X days.

4. The method of claim 1, wherein the cost benefit index corresponds to a single numerical value.

5. The method of claim 1, wherein the providing comprises providing the recommendation based upon an identified range that the cost benefit index corresponds to.

6. The method of claim 1, wherein the providing comprises:
identifying a cost benefit index threshold; and
adjusting an aspect of the recommendation based upon a relationship of the cost benefit index to the cost benefit index threshold.

7. The method of claim 1, wherein the recommendation comprises a plurality of potential action paths.

8. The method of claim 7, wherein each of the plurality of potential action paths is associated with a risk level.

9. The method of claim 8, wherein the risk level is selected from the group consisting of a low risk level, a medium risk level, and a high risk level.

10. The method of claim 7, wherein adherence to any of the plurality of potential action paths decreases the cost benefit index.

11. An electronic device, comprising:
a processor; and
a memory storing instructions executable by the processor to:
receive a data set comprising measured values for a plurality of parameters associated with an upcoming operational process associated with water quality, wherein each of the plurality of parameters is selected from the group consisting of: energy, chemicals, labor equipment, and a process efficiency value;
determine, by at least comparing the measured values against each other, a cost benefit index associated with the upcoming operational process; and
provide, based on the determined cost benefit index, a recommendation to maximize a benefit derived from the upcoming operational process based upon a cost to complete the upcoming operational process.

12. The electronic device of claim 11, wherein each of the plurality of parameters are associated with one of: a cost measure or a benefit projection.

13. The electronic device of claim 11, wherein the measured values originate from a past time X days before a present time and wherein the cost benefit index corresponds to the upcoming project designated for completion at a future time Y days after the present time, wherein the Y days is at least partially dependent on the X days.

14. The electronic device of claim 11, wherein the cost benefit index corresponds to a single numerical value.

15. The electronic device of claim 11, wherein the instructions executable by the processor to provide comprise instructions executable by the processor to provide the recommendation based upon an identified range that the cost benefit index corresponds to.

16. The electronic device of claim 11, wherein the instructions executable by the processor to provide comprise instructions executable by the processor to:
identify a cost benefit index threshold; and
adjust an aspect of the recommendation based upon a relationship of the cost benefit index to the cost benefit index threshold.

17. The electronic device of claim 11, wherein the recommendation comprises a plurality of potential action paths.

18. The electronic device of claim 17, wherein each of the plurality of potential action paths is associated with a risk level.

19. The method of claim 18, wherein the risk level is selected from the group consisting of a low risk level, a medium risk level, and a high risk level.

20. A computer program product, comprising:
a storage device that stores code, the code being executable by a processor and comprising:
code that receives a data set comprising measured values of a plurality of parameters associated with an upcoming operational process;
code that determines, by at least comparing the measured values against each other, a cost benefit index associated with the upcoming project; and
code that provides, based on the determined cost benefit index, a recommendation to maximize a benefit derived from the upcoming operational process based upon a cost to complete the upcoming operational process.
